(19) United States
(12) Patent Application Publication
(10) Pub. No.: US 2004/0214088 A1
(43) Pub. Date: Oct. 28, 2004

(54) Composite polymer electrolyte different morphologies for lithium secondary battery and method of manufacturing the same

(76) Inventors: Young Gi Lee, Daejeon-city (KR); Kwang Man Kim, Daejeon-city (KR); Kwang Sun Ryu, Daejeon-city (KR); Soon Ho Chang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/748,363

(22) Filed: Dec. 29, 2003

(30) Foreign Application Priority Data
Apr. 25, 2003 (KR) 2003-26419

(51) Int. Cl. H01M 10/40

(52) U.S. Cl. 429/309; 429/316; 429/317; 429/314

(57) ABSTRACT

A composite polymer electrolyte for a lithium secondary battery and a method of manufacturing the same are provided. The composite polymer electrolyte includes a composite film structure which includes a first porous polymer film with good mechanical properties and a second porous polymer film with submicro-scale morphology of more compact porous structure than the first porous polymer structure, coated on a surface of the first porous polymer film, and an electrolyte solution impregnated into the composite film structure. The different morphologies of the composite film structure enable to an increase in mechanical properties and ionic conductivity. Furthermore, the charge/discharge cycle performance and stability of a lithium metal polymer secondary battery are enhanced.

### BACKGROUND OF THE INVENTION

This application claims priority from Korean Patent Application No. 2003-26419, filed on Apr. 25, 2003, in the Korean Intellectual Property Office, the disclosure of which is incorporated herein in its entirety by reference.

1. Field of the Invention

The present invention relates to a polymer electrolyte for a lithium secondary battery and a method of manufacturing the same. More particularly, the present invention relates to a composite polymer electrolyte for a lithium secondary battery, which includes a porous polymer composite film structure of different morphologies impregnated with an electrolyte solution, and a method of manufacturing the same.

2. Description of the Related Art

Recently, as electric, electronic, communication, and computer industries are rapidly in progress, demand on secondary batteries with high performance and high stability is being increased. In particular, as electronic devices progressively become small, thin, and lightweight, in the office automation field, desktop computers are being replaced with laptop or notebook computers that are smaller and lighter than the desktop computers. Portable electronic devices such as camcorders and cellular phones are also rapidly being spread.

As electronic devices become small, thin, and lightweight, secondary batteries that are used as power supply sources for the electronic devices are also required to have higher performance. That is, developments have been rapidly made on lithium secondary batteries that can act as replacements of conventional lead storage batteries or lithium-cadmium batteries, satisfy the requirements of small-size, lightness, and high energy density, and are repeatedly chargeable and dischargeable.

The lithium secondary batteries include a cathode and an anode made of an active material that can induce intercalation and de-intercalation of lithium ions. An organic electrolyte or a polymer electrolyte that allows for the movement of the lithium ions is interposed between the cathode and the anode. The lithium secondary batteries generate electric energy by oxidation/reduction due to intercalation/de-intercalation of the lithium ions in the cathode and the anode.

The cathode of the lithium secondary batteries has a potential higher than the electrode potential of lithium, by as much as about 3 to 4.5 V, and is mainly made of complex oxide of lithium with transition metal for intercalation/de-intercalation of the lithium ions. For example, lithium cobalt oxide (LiCoO₂), lithium nickel oxide (LiNiO₂), and lithium manganese oxide (LiMnO₂) are mainly used as a cathode material. On the other hand, the anode is mainly made of a lithium metal, a lithium alloy, or a carbonaceous material that exhibits a chemical potential similar to the lithium metal upon the intercalation/de-intercalation of the lithium ions, so as to reversibly receive or emit the lithium ions while maintaining structural and electrical properties.

The lithium secondary batteries are classified into lithium ion batteries (LIBs) and lithium polymer batteries (LPBs) according to the types of electrolytes. While the lithium ion batteries use a liquid electrolyte/separation film system, the lithium polymer batteries use a polymer electrolyte. In particular, the lithium polymer batteries can be sub-classified into lithium metal polymer batteries (LMPBs) using a lithium metal as an anode and lithium ion polymer batteries (LIPBs) using carbon as the anode. In the lithium ion batteries using a liquid electrolyte, there arise problems due to instability of the liquid electrolyte. Although alternatives such as use of an electrode material capable of compensating for the instability of the liquid electrolyte or installation of a safety apparatus can be considered, a manufacture cost increases and it is difficult to increase the capacity of the batteries. On the contrary, the lithium polymer batteries have many advantages such as low manufacture cost, diversity of size and shape, and high voltage and large capacity by lamination. Therefore, attention has been paid to the lithium polymer batteries as next generation batteries.

In order for the lithium polymer batteries to be commercially available, the polymer electrolyte must satisfy the requirements such as excellent ionic conductivity, mechanical properties, and interfacial stability between it and electrodes. In particular, in the lithium metal polymer batteries, dendritic growth of lithium on a lithium anode, formation of dead lithium, or interfacial phenomenon between the lithium anode and the polymer electrolyte adversely affects the stability and cycle characteristics of the batteries. In view of these problems, developments on various polymer electrolytes have been in progress.

At an initial stage for developments of polymer electrolytes, solventless polymer electrolytes had been mainly studied. The solventless polymer electrolytes are manufactured by dissolving a mixture of a salt with polyethylene oxide or polypropylene oxide in a co-solvent, followed by casting (see EP78505 and U.S. Pat. No. 5,102,752). However, the solventless polymer electrolytes have very low ionic conductivity at room temperature.

As another example of the polymer electrolytes, there are disclosed gel polymer electrolytes having high ionic conductivity of more than 10⁻³ S/cm, manufactured in the form of a film after dissolving a salt and a common polymer such as polyacrylonitrile, polymethylmethacrylate, polyvinylchloride, and polyvinylidene fluoride in an organic solvent such as ethylene carbonate and propylene carbonate and a co-solvent [K. M. Abraham et al., J. Electrochem. Soc., 142, 1789, 1995]. However, these gel polymer electrolytes have automation process-related problems such as deterioration of mechanical properties due to the used organic solvent, a need of a specific process condition when actually used for the lithium polymer batteries, and removal of the co-solvent.

Recently, there is disclosed a method of manufacturing lithium secondary batteries, which includes: preparing a porous polymer matrix, laminating a cathode, the porous polymer matrix, and an anode to produce a laminate, and impregnating the laminate with an electrolyte solution [J. M. Tarascon et al., Solid State Ionics, 86-88, 49, 1996; and U.S. Pat. No. 5,456,000]. In this case, although ionic conductivity is slightly enhanced, mechanical properties are little enhanced.

In spite of numerous attempts to improve the physicochemical properties of polymer electrolytes as described above, current polymer electrolytes still exhibit low ionic conductivity and insufficient mechanical properties, as compared to the electrolyte solution/separation film system of the lithium ion batteries. This is because due to compatibility between a polymer matrix and an electrolyte solution, an electrolyte film becomes flexible as impregnation of the polymer matrix with the electrolyte solution increases. Also, since the electrolyte film has more compact microporous morphology relative to the separation film, an ion transfer path is curved, and thus, an ion transfer distance becomes long. For this reason, the lithium metal polymer batteries exhibit drastically low ionic conductivity, relative to the lithium ion batteries, even though dendritic growth of lithium at a surface of a lithium anode is slightly prevented. Therefore, thin film formation for the polymer electrolyte is difficult and the total resistance of batteries is increased, thereby deteriorating charge/discharge cycle performance.

### SUMMARY OF THE INVENTION

The present invention provides a thin film, composite polymer electrolyte for a lithium secondary battery which has improvements in mechanical properties, impregnation and maintenance of an electrolyte solution into a porous matrix, and ionic conductivity.

The present invention also provides a simplified method of manufacturing the thin film, composite polymer electrolyte for a lithium secondary battery.

According to an aspect of the present invention, there is provided a composite polymer electrolyte for a lithium secondary battery. The composite polymer electrolyte comprises a composite film structure which comprises a first porous polymer film with micro-scale morphology and a second porous polymer film with submicro-scale morphology coated on a surface of the first porous polymer film. The composite film structure is impregnated with an electrolyte solution. The first porous polymer film may have a thickness of 10 to 25 μm and the second porous polymer film may have a thickness of 0.5 to 10 μm. The second porous polymer film may comprise an inorganic material.

According to another aspect of the present invention, there is provided a method of manufacturing a composite polymer electrolyte for a lithium secondary battery. A first porous polymer film with micro-scale morphology is prepared. A microporous polymer with submicro-scale morphology and an inorganic material are uniformly dissolved in a predetermined ratio in a co-solvent to produce a solution. The first porous polymer film is coated with the solution to form a second porous polymer film. Consequently, a composite film structure comprised of the first porous polymer film and the second porous polymer film that are different in morphologies is produced. The composite film structure is impregnated with an electrolyte solution.

The polymer electrolyte for a lithium secondary battery according to the present invention has excellent mechanical properties and ionic conductivity by the composite film structure with different morphologies. Also, erosion of a lithium anode and dendritic growth of lithium on a surface of the lithium anode are prevented, thereby preventing a short-circuit of the battery. Furthermore, the charge/discharge cycle performance and stability of a lithium metal polymer secondary battery are remarkably enhanced. Still furthermore, the polymer electrolyte of the present invention can be manufactured in the form of an ultra-thin film and a manufacture process is also simplified.

### BRIEF DESCRIPTION OF THE DRAWINGS

The above and other features and advantages of the present invention will become more apparent by describing in detail exemplary embodiments thereof with reference to the attached drawings in which:

FIG. 1 depicts a schematic structure of a composite polymer electrolyte for a lithium secondary battery according to a preferred embodiment of the present invention;

FIG. 2 is a flowchart that illustrates a process of manufacturing a composite polymer electrolyte for a lithium secondary battery according to a preferred embodiment of the present invention;

FIG. 3 is a graph showing ionic conductivities of composite polymer electrolytes according to the present invention;

FIG. 4 is a graph showing charge/discharge characteristics of unit batteries using composite polymer electrolytes according to the present invention; and

FIG. 5 is a graph showing cycle performance of unit batteries using composite polymer electrolytes according to the present invention.

### DETAILED DESCRIPTION OF THE INVENTION

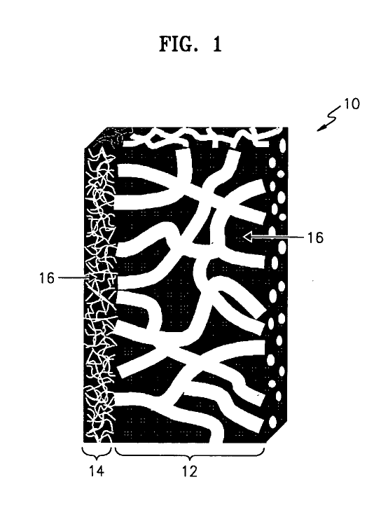

FIG. 1 depicts a schematic structure of a composite polymer electrolyte for a lithium secondary battery according to a preferred embodiment of the present invention.

Referring to FIG. 1, a composite polymer electrolyte 10 for a lithium secondary battery according to the present invention includes a composite film structure which includes a first porous polymer film 12 with micro-scale morphology and a second porous polymer film 14 with submicro-scale morphology. The second porous polymer film 14 is coated on a surface of the first porous polymer film 12. Preferably, the first porous polymer film 12 has a thickness of 10 to 25 μm and the second porous polymer film 14 has a thickness of 0.5 to 10 μm.

The first porous polymer film 12 may be made of polyethylene, polypropylene, polyimide, polysulfone, polyurethane, polyvinylchloride, cellulose, nylon, polyacrylonitrile, polyvinylidene fluoride, polytetrafluoroethylene, a copolymer or blend thereof.

The second porous polymer film 14 may be made of a vinylidene fluoride based polymer, an acrylate based polymer, a copolymer or blend thereof. Preferably, the second porous polymer film 14 is made of a copolymer of vinylidene fluoride and hexafluoropropylene, a copolymer of vinylidene fluoride and trifluoroethylene, a copolymer of vinylidene fluoride and tetrafluoroethylene, polymethylacrylate, polyethylacrylate, polymethylmethacrylate, polyethylmethacrylate, polybutylacrylate, polybutylmethacrylate, polyvinylacetate, polyethylene oxide, polypropylene oxide, a copolymer or blend thereof.

There is no particular limitation on the molecular weight of the first porous polymer film 12 and the second porous polymer film 14. For example, the first porous polymer film 12 and the second porous polymer film 14 may have a molecular weight within a range of 10,000 to 1,000,000.

The second porous polymer film 14 may comprise an inorganic material. The inorganic material may be selected from the group consisting of silica, talc, alumina (Al₂O₃), [symbol] -LiAlO₂, TiO₂, and zeolite. The inorganic material may be added in an amount of 1 to 100% by weight, preferably about 1 to 50% by weight, based on the total weight of the polymer of the second porous polymer film 14.

The composite film structure comprised of the first porous polymer film 12 and the second porous polymer film 14 is impregnated with an electrolyte solution 16. The electrolyte solution 16 is impregnated in the composite film structure in an amount of 1 to 1,000% by weight, preferably about 1 to 500% by weight, based on the total weight of the polymer of the composite film structure.

The electrolyte solution 16 may be made of ethylene carbonate, propylene carbonate, dimethyl carbonate, diethyl carbonate, methylethyl carbonate, tetrahydrofuran, 2-methyltetrahydrofuran, dimethoxyethane, methyl formate, ethyl formate, gamma-butyrolactone, or a mixture thereof.

A lithium salt is dissolved in the electrolyte solution 16 in an amount of about 1 to 200% by weight, preferably about 1 to 100% by weight, based on the total weight of the polymer of the composite film structure.

The lithium salt may be at least one selected from the group consisting of lithium perchlorate (LiClO₄), lithium triflate (LiCF₃SO₃), lithium hexafluorophosphate (LiPF₆), lithium tetrafluoroborate (LiBF₄), and lithium trifluoromethanesulfonylimide (LiN(CF₃SO₂)₂).

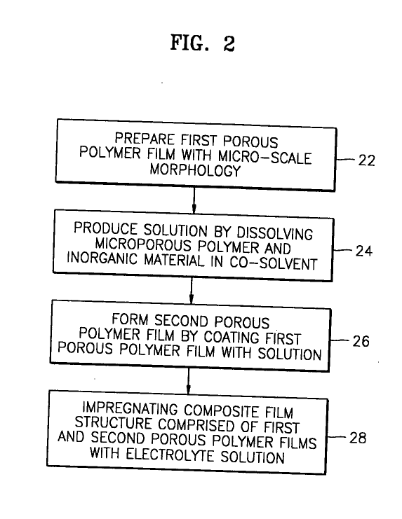

FIG. 2 is a flowchart that illustrates a process of manufacturing a composite polymer electrolyte for a lithium secondary battery according to a preferred embodiment of the present invention.

Referring to FIGS. 1 and 2, first, the first porous polymer film 12 with micro-scale morphology is formed to a thickness of about 10 to 25 μm (step 22).

Next, a microporous polymer with submicro-scale morphology and an inorganic material are uniformly dissolved in a predetermined ratio in a co-solvent to produce a solution (step 24). Here, the co-solvent may be selected from the group consisting of acetone, dimethylformamide, dimethylsulfoxide, N-methylpyrrolidone, and a mixture thereof.

The solution is coated on a surface of the first porous polymer film 12 to form the second porous polymer film 14 with a thickness of about 0.5 to 10 μm (step 26). As a result, the composite film structure comprised of the first porous polymer film 12 and the second porous polymer film 14 that are different in morphologies is produced.

Next, the composite film structure is impregnated with the electrolyte solution 16 to complete the composite polymer electrolyte structure with different morphologies as shown in FIG. 1 (step 28).

Hereinafter, the method of manufacturing composite polymer electrolytes for lithium secondary batteries according to the present invention will be described more specifically by Examples. It is, however, to be borne in mind that the following Examples are provided only for illustrations and thus the present invention is by no means limited to or by them.

### EXAMPLE 1

In order to manufacture a composite polymer electrolyte for a lithium secondary battery according to the process illustrated in FIGS. 1 and 2, first, a copolymer of vinylidene fluoride and hexafluoropropylene was dissolved in acetone used as a co-solvent to obtain a solution containing 2% by weight of the copolymer. Then, silica was added to the solution in an amount of 20% by weight, based on the total weight of the copolymer. A dispersion thus obtained was cast on a porous polyethylene film with a thickness of 25 μm and the co-solvent was then evaporated. As a result, a composite film structure with different morphologies in which a compact microporous polymer film was coated on a surface of the porous polyethylene film was obtained. The obtained composite film structure was transferred into a glove box of an argon atmosphere and then immersed in an electrolyte solution in which 1M lithium hexafluorophosphate was contained in a mixture solvent (1:1, molar ratio) of ethylene carbonate and dimethyl carbonate to produce a polymer electrolyte.

### EXAMPLE 2

A polymer electrolyte was manufactured in the same manner as in Example 1 except that 5% by weight of a coating solution was used.

### EXAMPLE3

A polymer electrolyte was manufactured in the same manner as in Example 1 except that 10% by weight of a coating solution was used.

### EXAMPLE 4

A polymer electrolyte was manufactured in the same manner as in Example 1 except that polyethylene oxide was used instead of the copolymer of vinylidene fluoride and hexafluoropropylene.

### EXAMPLE 5

A polymer electrolyte was manufactured in the same manner as in Example 1 except that 10% by weight of TiO₂ was used instead of the silica.

### EXAMPLE 6

A polymer electrolyte was manufactured in the same manner as in Example 1 except that a porous polypropylene film with a thickness of 16 μm was used instead of the porous polyethylene film.

### COMPARATIVE EXAMPLE

In order to perform characteristics comparison with the polymer electrolytes obtained in Examples 1 through 6, a porous polyethylene film was immersed in an electrolyte solution in which 1M lithium hexafluorophosphate was contained in a mixture solvent (1:1, molar ratio) of ethylene carbonate and dimethyl carbonate, to produce a separation film/liquid electrolyte system.

### EXAMPLE 7

In order to measure a charge/discharge cycle, individual unit batteries were manufactured using the composite polymer electrolytes obtained in Examples 1, 2, and 3, and the separation film/liquid electrolyte system obtained in Comparative Example. Cathode plates were made of a mixture of 80% by weight of lithium-manganese-nickel powders, 12% by weight of a conductive agent, and 8% by weight of a binder. Lithium metal foils were used as anode plates. Charge/discharge cycles were repeated in such a way that a charge was carried out until 4.8 V and then a discharge was carried out until 2.0 V, under a charge/discharge current density of 1 mA (C/5 rate).

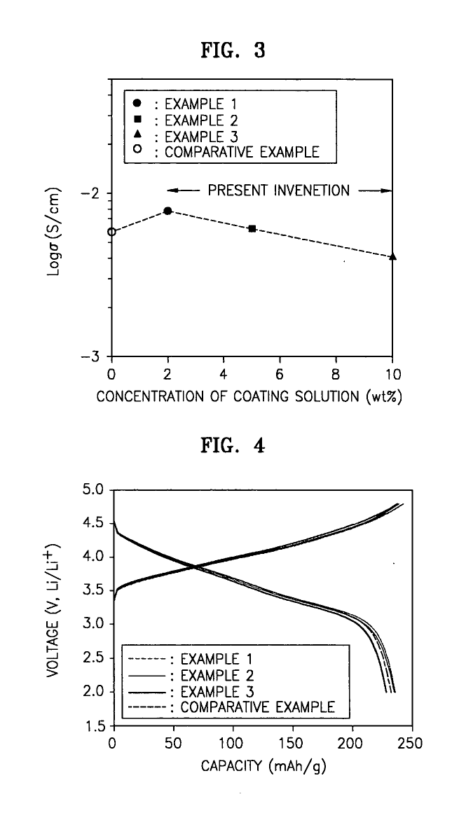

FIG. 3 is a comparative graph showing ionic conductivities of the composite polymer electrolytes of the present invention and the separation film/liquid electrolyte system of Comparative Example. The composite polymer electrolytes of the present invention were those obtained in Examples 1, 2, and 3.

As shown in FIG. 3, the individual polymer electrolytes obtained in Examples 1, 2, and 3 exhibited similar or superior ionic conductivities, as compared to Comparative Example.

FIG. 4 is a graph showing charge/discharge characteristics of unit batteries using composite polymer electrolytes of the present invention. In detail, FIG. 4 is a comparative graph showing initial charge/discharge characteristics of unit batteries using the polymer electrolytes obtained in Examples 1, 2, and 3, and the separation film/liquid electrolyte system obtained in Comparative Example.

As shown in FIG. 4, the unit batteries using the composite polymer electrolytes of the present invention exhibited initial charge/discharge characteristics similar to Comparative Example commercially available. This result indicates that the initial charge/discharge characteristics of the unit batteries using the composite polymer electrolytes of the present invention are within an acceptable range.

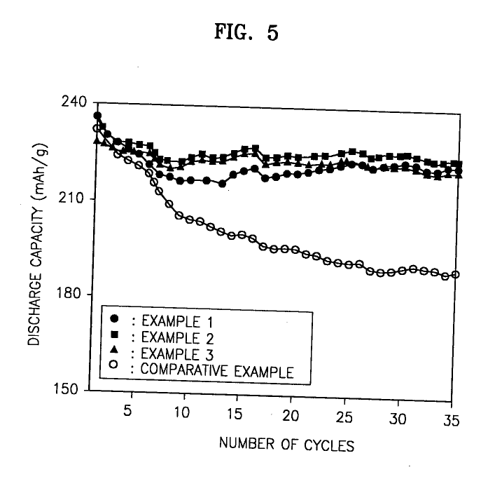

FIG. 5 is a graph showing cycle performance of unit batteries using composite polymer electrolytes of the present invention. In detail, FIG. 5 is a comparative graph showing the cycle performance of unit batteries using the polymer electrolytes obtained in Examples 1, 2, and 3 and the separation film/liquid electrolyte system obtained in Comparative Example.

As shown in FIG. 5, the unit batteries using the composite polymer electrolytes of the present invention exhibited the maintenance ability of excellent discharge capacity, as compared to Comparative example.

As is apparent from the above description, the polymer electrolyte for a lithium secondary battery according to the present invention includes a composite film structure with different morphologies. The composite film structure includes a first porous polymer film with good mechanical properties, and a second porous polymer film with submicro-scale morphology of more compact porous structure than the first porous polymer film, coated on a surface of the first porous polymer film. The different morphologies of the composite film structure can provide excellent mechanical properties and ionic conductivity, as compared to a conventional gel polymer electrolyte. Furthermore, erosion of a lithium anode and dendritic growth of lithium on a surface of the lithium anode can be prevented, thereby preventing a short-circuit of the battery. Still furthermore, charge/discharge cycle performance and stability of a lithium metal polymer secondary battery can be remarkably enhanced.

In addition, the polymer electrolyte for a lithium battery of the present invention can be manufactured in the form of an ultra-thin film. Also, post-injection of the electrolyte solution can simplify a manufacture process, thereby increasing a process yield.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A composite polymer electrolyte for a lithium secondary battery, which comprises:
a composite film structure comprising a first porous polymer film with micro-scale morphology and a second porous polymer film with submicro-scale morphology coated on a surface of the first porous polymer film; and
an electrolyte solution impregnated into the composite film structure.

2. The composite polymer electrolyte of claim 1, wherein the first porous polymer film is made of polyethylene, polypropylene, polyimide, polysulfone, polyurethane, polyvinylchloride, cellulose, nylon, polyacrylonitrile, polyvinylidene fluoride, polytetrafluoroethylene, a copolymer or blend thereof.

3. The composite polymer electrolyte of claim 1, wherein the second porous polymer film is made of a vinylidene fluoride based polymer, an acrylate based polymer, a copolymer or blend thereof.

4. The composite polymer electrolyte of claim 3, wherein the second porous polymer film is made of a copolymer of vinylidene fluoride and hexafluoropropylene, a copolymer of vinylidene fluoride and trifluoroethylene, a copolymer of vinylidene fluoride and tetrafluoroethylene, polymethylacrylate, polyethylacrylate, polymethylmethacrylate, polyethylmethacrylate, polybutylacrylate, polybutylmethacrylate, polyvinylacetate, polyethylene oxide, polypropylene oxide, a copolymer or blend thereof.

5. The composite polymer electrolyte of claim 1, wherein the first porous polymer film has a thickness of 10 to 25 μm and the second porous polymer film has a thickness of 0.5 to 10 μm.

6. The composite polymer electrolyte of claim 1, wherein the second porous polymer film comprises an inorganic material.

7. The composite polymer electrolyte of claim 6, wherein the inorganic material is selected from the group consisting of silica, talc, alumina (Al₂O₃), [symbol] LiAlO₂, TiO₂, and zeolite.

8. The composite polymer electrolyte of claim 6, wherein the inorganic material is added in an amount of 1 to 100% by weight, based on the total weight of the polymer of the second porous polymer film.

9. The composite polymer electrolyte of claim 1, wherein the electrolyte solution is made of ethylene carbonate, propylene carbonate, dimethyl carbonate, diethyl carbonate, methylethyl carbonate, tetrahydrofuran, 2-methyltetrahydrofuran, dimethoxyethane, methyl formate, ethyl formate, gamma-butyrolactone, or a mixture thereof.

10. The composite polymer electrolyte of claim 1, wherein the electrolyte solution is impregnated in the composite film structure in an amount of 1 to 1,000% by weight, based on the total weight of the polymer of the composite film structure.

11. The composite polymer electrolyte of claim 1, wherein the electrolyte solution comprises at least one lithium salt selected from the group consisting of lithium perchlorate (LiClO₄), lithium triflate (LiCF₃SO₃), lithium hexafluorophosphate (LiPF₆), lithium tetrafluoroborate (LiBF₄), and lithium trifluoromethanesulfonylimide (LiN(CF₃SO₂)₂).

12. The composite polymer electrolyte of claim 11, wherein the lithium salt is dissolved in the electrolyte solution in an amount of 1 to 200% by weight, based on the total weight of the polymer of the composite film structure.

13. A method of manufacturing a composite polymer electrolyte for a lithium secondary battery, the method comprising:
preparing a first porous polymer film with micro-scale morphology;
uniformly dissolving a microporous polymer with submicro-scale morphology and an inorganic material in a co-solvent in a predetermined ratio to produce a solution;
forming a second porous polymer film by coating the first porous polymer film with the solution to produce a composite film structure which comprises the first porous polymer film and the second porous polymer film that are different in morphologies; and
impregnating the composite film structure with an electrolyte solution.

14. The method of claim 13, wherein the co-solvent is selected from the group consisting of acetone, dimethylformamide, dimethylsulfoxide, N-methylpyrrolidone, and a mixture thereof.
